(19) United States
(12) Patent Application Publication
(10) Pub. No.: US 2021/0383012 A1
(43) Pub. Date: Dec. 9, 2021

(54) SYSTEMS AND METHODS FOR IN MEMORY PATTERN MATCHING LANGUAGE TRANSFORMATION

(71) Applicant: Verizon Patent and Licensing Inc., Basking Ridge, NJ (US)

(72) Inventors: Robert J. Alkire, Flower Mound, TX (US); Kiran Ladkat, Flower Mound, TX (US)

(21) Appl. No.: 16/891,131

(22) Filed: Jun. 3, 2020

(51) Int. Cl. G06F 21/62; G06F 40/143; G06F 9/445

(52) U.S. Cl. CPC G06F 21/6227; G06F 2221/2141; G06F 9/44505; G06F 40/143

(57) ABSTRACT

Systems and methods described herein optimize use of computing resources to perform file transformations by using in memory pattern matching. A computing device receives a configuration file for transforming data reports from a data source, creates object instances for commands in the configuration file; and obtains a source document generated from the data source. The computing device performs a single character-by-character scan of the source document and creates an ordered list of matching terms corresponding to the objet instances. Each of the matching terms identifies a location within the source document. The computing device allocates, based on the ordered list of matching terms, a RAM block for transforming the source document and performs operations of the object instances in reverse order of the ordered list of matching terms. The operations include memory move operations within the allocated RAM block. The performing creates a transformed source document for a user.

### BACKGROUND

Large organizations typically manage data structures that include information relating to multiple customers or that include different levels of access restrictions. These organizations may seek to generate, from the data structures, reports that are designed for particular customers or users with access privileges for only certain data.

### BRIEF DESCRIPTION OF THE DRAWINGS

FIG. 1 is a diagram illustrating concepts described herein;

FIG. 2 is a diagram illustrating an exemplary environment in which systems and/or methods described herein may be implemented;

FIG. 3 is a block diagram of exemplary components of a device that may correspond to one of the devices of FIG. 2;

FIG. 4 is a block diagram of exemplary logical components of the report server of FIG. 2; and

FIG. 5 is a flow diagram illustrating an exemplary process associated with transforming an input fie using in memory pattern matching, according to an implementation described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Transformed target documents may be generated for applications and customers, for example, on source Java Script Object Notation (JSON) or Extensible Markup Language (XML) documents from a request or before sending a response. The system actors and customers (referred to herein collectively as “users,” which may include applications, network functions, persons, etc.) may have different access rights and/or levels of permission. That is, some users may be allowed to see data that others may not. One way a service provider can ensure that the contents of the reports are not accessible to unauthorized users is to transform certain data by performing replacements or filtering. Proving transformed data can delay response times, particularly for large source documents. There is a need for extremely performant automated source document transformation systems that can be implemented by an application optimize these operations.

Systems and/or methods described herein optimize use of computing resources to perform file transformations by using in memory pattern matching. Implementations described herein may obtain a source document in XML format and one or more matcher JSON transform configuration files (MJTCFs) that define requirement transformations for the source document. Using a one-pass scan through each character of the source document, the systems and/or methods may match, based on the MJTCF(s), terms in the source document that need to be replaced, removed, or de-identified (e.g., removing identification information). These MJTCF(s) are converted into class object instances (e.g., an instantiation of a Java class, also referred to herein as “matchers” or “matcher instances”) of a matcher class. The scan process is initiated for the source document with the MJTCF matchers and for any matcher that completes a match of all characters which it is testing, the matcher (with all of its current state) is saved and put into a “matched list.” A done with default state of the matcher is created for subsequent matching comparisons. Each saved matcher identifies the location within input source document 110 where the match occurred as well as the ending point where the match ends and the length (i.e., start-end). The start, end, and length may be integer offsets from the beginning of the source document. A memory block is allocated to rapidly perform transformation operations (e.g., replacements, removal, etc.) using memory move actions within the allocated memory. No new memory is allocated, and transformation operations may be optimized to use machine code level implementation.

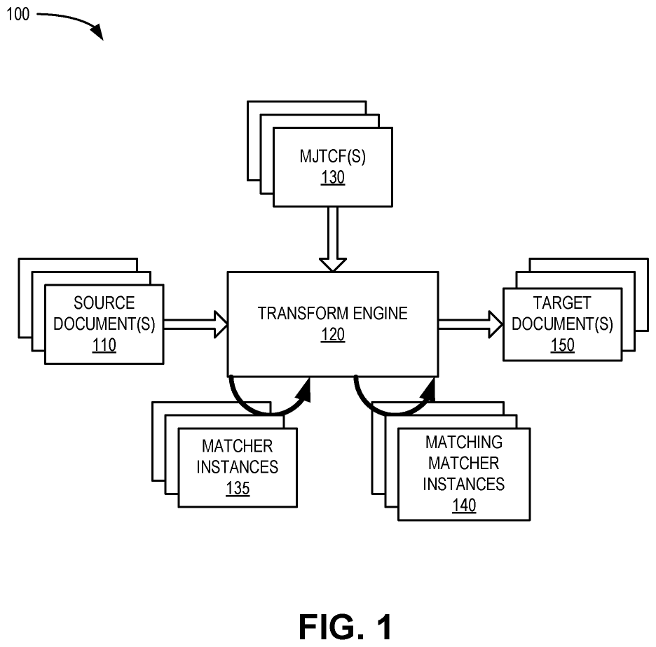

FIG. 1 is a diagram illustrating concepts described herein. Source documents 110 may be generated from a database. Each of source documents 110 may represent, for example, a subset of information, from the database, that is targeted for a particular user. Source documents 110 may include, for example, XML file format or a JSON file format. Each source document 110 may include, for example, a large number of records that include some data that is not applicable or authorized for the requesting user. For example, source documents 110 may be formatted for use by a service provider, but not necessarily for a customer. MJTCFs 130 may provide configuration guidelines for each user. MJTCFs 130 may include, for example, instructions for converting source document 110 to meet user access or authorization levels.

In implementations described herein, a transform engine 120 may receive source documents 110 (e.g., XML input files) for a particular user and retrieve a corresponding MJTCF 130. Transform engine 120 may apply information from the retrieved MJTCF 130 to a particular source document 110 to generate a transformed source document, referred to herein as a target document 150.

In one implementation, MJTCF 130 may include a JSON configuration file that specifies a set of commands to perform on source document 110. As non-limiting examples, commands may include instructions for replacing, removing, or obfuscating some data in source document 110 (e.g., to adjust the content of source document 110 to match the access level of a requesting user). Transform engine 120 may read MJTCF(s) 130 and create a corresponding object instance 135 (e.g., a JAVA object instance, also referred to as “matcher instance 135”) that implements each command. Matching matcher instances 140 may include a list of commands that refer to the actions required to process the source document 110 into the transformed target document 150 that is being produced. Each command from matching matcher instances 140 will be executed in reverse order by the transform engine 120.

Transform engine 120 may convert MJTCF(s) 130 into a matcher instance 135 list and processes the source document 110 using the matcher instances 135 to produce the matching matcher instances 140. Transform engine 120 may use, for example, a Visitor design pattern on the matching matcher instances 140 to calculate the memory required for the target document 150. Transform engine 120 may then execute each matching matcher instance 140 against the source document 110, again using the Visitor pattern. This process generates into the allocated memory block of the transformed target document 150 for the user.

As described further herein, transform engine 120 applies the instructions in an optimized manner, executed entirely in random access memory (RAM). According to an implementation, transform engine 120 loads the source document 110 into memory (unless source document 110 is already in memory, as may be the case for server request and responses) and scan source document 110 one character (e.g., an individual number, letter, or symbol) at a time. Each matcher instance 135 in the list of commands checks the current character of source document 110 (e.g., set into local char variable for performance) for a match (e.g., to match a character string in the matcher instance 135). If there is not a match for a particular command, the matcher instance 135 is removed from a list of possible matches. If there is a match for the particular command for the current character, then the next character from the source document 110 is checked. Each term (e.g., data) in the source document 110 is checked for all matcher instances 135. When no matcher instances 135 exist that are still matching a term, then no further matchings for that matcher are performed, and matching restarts with the complete list of matchers for the next term in source document 110.

When the last character of a term is reached, any matcher instances 135 that found a complete match are moved into matching matcher instance 140. One or more matcher instances 135 may continue the matching process for subsequent characters of the source document 110, as a match of a matcher instance 135 is not limited by word boundaries (i.e., spaces) and may require multiple words. Thus, for each character checked, a minimum number of comparisons is performed as matcher instances that failed a single character match are eliminated from subsequent checks for future characters of the term characters.

For any matcher instance 135 that completes a match of all characters for which it is testing, the occurrence (of the match) is put into the matching matcher instances 140 and the occurrence is cloned. The clone with default state (e.g., no location information set) of the matcher instance is created for subsequent snatching comparisons. Each instance in the matching matcher instances 140 identifies the location within source document 110 where the match occurred. The location information includes the start and end locations (e.g., offsets from the beginning of source document 110) and a calculated length (start minus end). Once the source document 110 has been completely scanned, all of the matching matcher instances 135 will reside in matching matcher instances 140 in the order the matches are found.

Transform engine 120 will process the completed matched 140 against source document 110 in reverse order. As described further herein, processing matched 140 in reverse order prevents any alterations of the in-memory target source document 110 from offsetting the location of previous matches. Processing matched 140 may include transform engine 120 executing the instances to perform their respective operations (e.g., to remove, replace, etc.). When executing each instance, any unaltered data between the end of a new match and the beginning of a previous match is preserved by performing a memory move of the unaltered data and any data from the previous match.

Completion of processing of matched 140 against source document 110 results in a formatted target document 150, which a recipient application, for example, uses as needed. Using implementations described herein, extremely large (e.g., gigabyte-sized) files can have hundreds or even thousands of operations (e.g., matcher instances 135) performed, and the entire transformation from source document 110 to target document 150 can occur in seconds with an average transform operation occurring in microseconds.

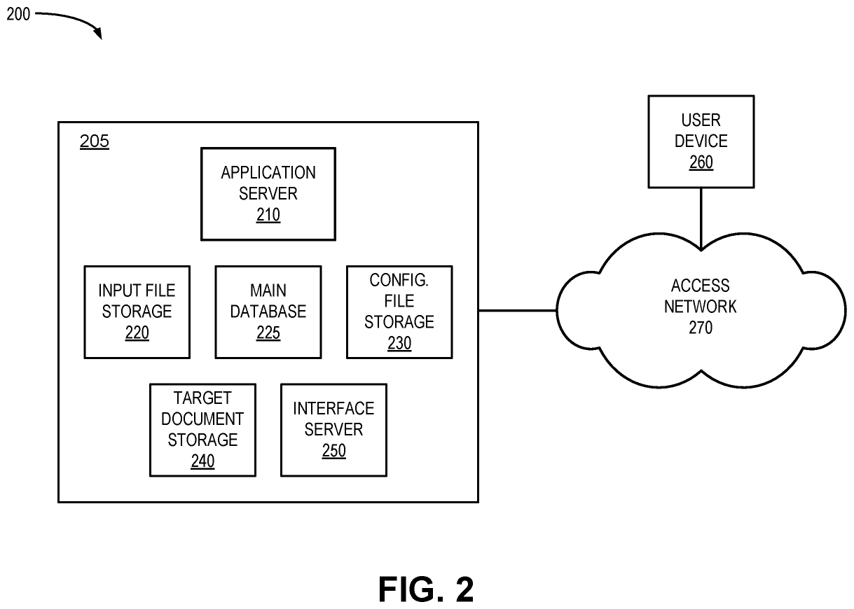

FIG. 2 is an exemplary environment 200 in which systems and/or methods described herein may be implemented, according to an implementation. As illustrated, environment 200 may include a service provider network 205 and a user device 260 interconnected by an access network 270. Service provider network 205 may include a report server 210, input file storage 220, a main database 225, configuration file storage 230, target document storage 240, and an interface server 250.

Service provider network 205 may generally include network devices to manage equipment and/or services, such as telecommunications equipment/services, to customers. Service provider network 205 may include a local area network (LAN), an intranet, a private wide area network (WAN), etc. In one implementation, service provider network 205 may implement network connections or Virtual Private Network (VPN) connections for providing communication between, for example, any of report server 210, input file storage 220, configuration file storage 230, target document storage 240, and interface server 250. Service provider network 205 may be protected/separated from other networks, such as network 270, by a firewall. Although shown as a single element in FIG. 2, service provider network 205 may include a number of separate networks.

Report server 210 may include server entities, or other types of computation or communication devices, that are capable of performing analysis and/or converting files stored in, for example, input file storage 220. According to an implementation, report server 210 may include transform engine 125.

Report server 210 may retrieve a data file (e.g., source document 110) from input file storage 220 and a corresponding configuration file (e.g., MJTCF 130) from configuration file storage 230. Based on instructions in the configuration file, report server 210 may analyze the data file and generate a target document (e.g., target document 150). Report server 210 may store the target document, for example, in target document storage 240 or provide the target document to interface server 250.

Input file storage 220 may include a database or another memory component to store files that are responsive to customer requests (e.g., source document 110). For example, input file storage 220 may include customer-specific information extracted from a larger database of multiple customers, such as main database 225. As a particular example, input file storage 220 may include an XLM or JSON file, extracted from a main database 225, with records for a particular customer.

Main database 225 may include a database or another memory component to store data relating to multiple customers and/or systems. For example, main database 225 may include a configuration management database, inventory database, sales database, or another type of database from which reports (e.g., customer or system-specific reports) may be extracted.

Configuration file storage 230 may include a database or another memory component to store files that provide configuration settings for different users. For example, configuration file storage 230 may include JSON configuration files (e.g., MJTCF 130) that define criteria to enforce access levels/restrictions for particular users. In one implementation, the files in configuration file storage 230 may be generated by or for a customer before the customer places a request for information. For example, a configuration file for a particular customer may be generated and used to format repeated requests for information from input file storage 220/main database 225.

Target document storage 240 may include a database or another memory component to store files generated by report server 210. For example, target document storage 240 may store output data files (e.g., target documents 150) in formats for particular customers (e.g., based on MJTCFs from configuration file storage 230). Files in target document storage 240 may be retrieved by customers or applications (e.g., using user device 260). In one implementation, target document storage 240 may include a shared platform that permits customers to retrieve particular files using SSH File Transfer Protocol (SFTP) procedures.

Interface server 250 may include server entities, or other types of computation or communication devices, to provide an interface to customers (e.g., using user device 260) or applications (e.g., executing on user device 260). Interface server 250 may include for example, a web server or portal interface to access services in service provider network 205. In one implementation, interface server 250 may receive a request from user device 260 to retrieve a particular file or perform a particular query. The request may cause, for example, service provider network 205 to generate an XML file for input file storage 220. The XML file may be used by report server 210 to generate a corresponding target document for target document storage 240. In another implementation, interface server 250 may provide a user interface to solicit information to generate a customer-specific or application-specific configuration file to store in configuration file storage 230.

User device 260 may include a computational or communication device. User device 260 may include, for example, a desktop computer, a laptop computer, a smart phone, a personal digital assistant (PDA), etc., used for general computing and communication tasks. User device 260 may be configured to communicate with devices in service provider network 205 (e.g., via network 270). According to an implementation, user device 260 may include one or more applications to request and/or receive target documents 150.

Access network 270 may include a local area network (LAN); an intranet; the Internet; a wide area network (WAN), such as a cellular network, a satellite network, a fiber optic network, a private WAN, or a combination of the Internet and a private WAN; etc., that is used to transport data. Although shown as a single element in FIG. 2, network 270 may include a number of separate networks to provide services to user devices 260.

The network configuration and communications described in connection with FIG. 2 provide an illustrative and non-limiting use case in which in memory pattern matching language transformation described herein may be applied. In FIG. 2, the particular arrangement and number of components of network 200 are illustrated for simplicity. In practice there may be more service provider networks 205, report servers 210, input file storage 220, main databases 225, configuration file storage 230, target document storage 240, interface servers 250, user devices 260, and/or networks 270. Components of system 200 may be connected via wired and/or wireless links.

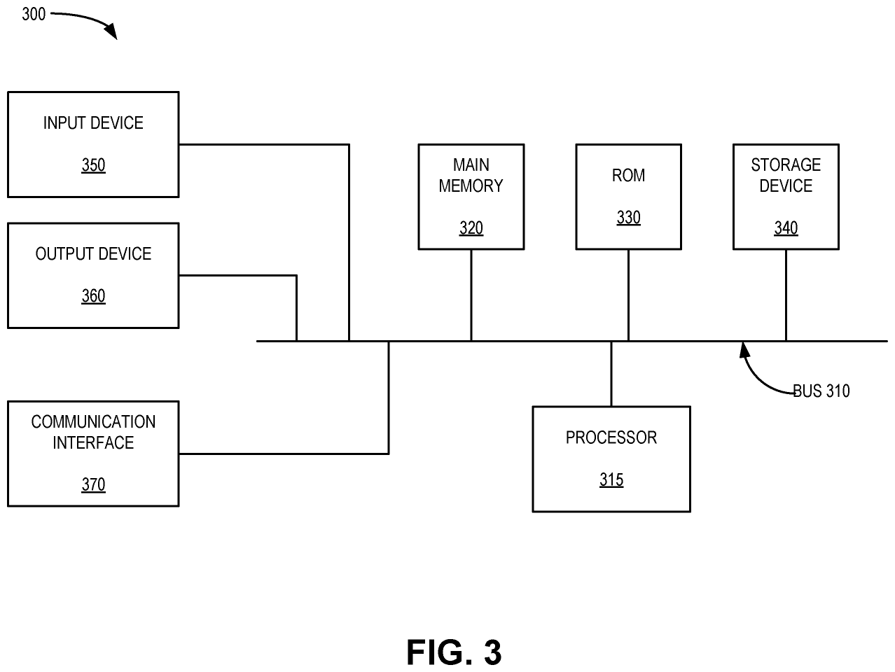

FIG. 3 is a diagram that depicts exemplary components of a device 300 on which transform engine 120 may be implemented. For example, device 300 may correspond to report server 210. Device 300 may include a bus 310, a processor 315, a main memory 320, a read only memory (ROM) 330, a storage device 340, an input device 350, an output device 360, and a communication interface 370. Bus 310 may include a path that permits communication among the other components of device 300.

Processor 315 may include one or more processors or microprocessors which may interpret and execute stored instructions associated with processes. Additionally, or alternatively, processor 315 may include processing logic that implements the processes. For example, processor 315 may include, but is not limited to, programmable logic such as Field Programmable Gate Arrays (FPGAs) or accelerators. Processor 315 may include software, hardware, or a combination of software and hardware for executing the processes described herein.

Main memory 320 may include a RAM or another type of dynamic storage device that may store information and, in some implementations, instructions for execution by processor 315. According to an implementation, main memory 330 may be configured to support processing of large files (e.g., multiple gigabytes) as described herein. ROM 330 may include a ROM device or another type of static storage device (e.g., Electrically Erasable Programmable ROM (EEPROM)) that may store static information and, in some implementations, instructions for use by processor 315. Storage device 340 may include a magnetic, optical, and/or solid state (e.g., flash drive) recording medium and its corresponding drive. Main memory 320, ROM 330, and storage device 340 may each be referred to herein as a “non-transitory computer-readable medium” or a “non-transitory storage medium.” The processes/methods set forth herein can be implemented as instructions that are stored in main memory 320, ROM 330 and/or storage device 340 for execution by processor 315.

Input device 350 may include devices that permit an operator to input information to device 300, such as, for example, a keypad or a keyboard, a display with a touch sensitive panel, voice recognition and/or biometric mechanisms, etc. Output device 360 may include devices that output information to the operator, including a display, a speaker, etc. Input device 350 and output device 360 may, in some implementations, be implemented as a user interface (UI), such as a touch screen display, that displays UI information, and which receives user input via the UI. Communication interface 370 may include one or more transceivers that enable device 300 to communicate with other devices and/or systems. For example, communication interface 370 may include a wired or wireless transceiver for communicating with a source of source documents 110 (e.g., input file storage 220) or a destination for target documents 150 (e.g., target document storage 240 and/or user device 260).

Device 300 may perform certain operations or processes, as may be described herein. Device 300 may perform these operations in response to processor 315 executing software instructions contained in a computer-readable medium, such as memory 330. A computer-readable medium may be defined as a physical or logical memory device. A logical memory device may include memory space within a single physical memory device or spread across multiple physical memory devices. The software instructions may be read into main memory 320 from another computer-readable medium, such as storage device 340, or from another device via communication interface 370. The software instructions contained in main memory 320 may cause processor 315 to perform the operations or processes, as described herein. Alternatively, hardwired circuitry (e.g., logic hardware) may be used in place of, or in combination with, software instructions to implement the operations or processes, as described herein. Thus, exemplary implementations are not limited to any specific combination of hardware circuitry and software.

The configuration of components of device 300 illustrated in FIG. 3 is for illustrative purposes. Other configurations may be implemented. Therefore, device 300 may include additional, fewer and/or different components, arranged in a different configuration, than depicted in FIG. 3.

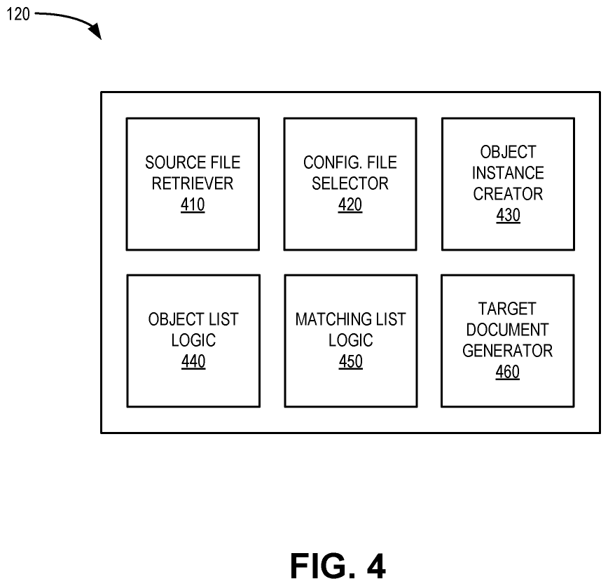

FIG. 4 is a block diagram of exemplary logical components of transform engine 120, according to an implementation where transform engine 120 is used with a report processing environment. The functions described in connection with the logical components of FIG. 4 may be performed by one or more components of FIG. 2, such as report server 210. As shown in FIG. 4, transform engine 120 may include a source file retriever 410, a configuration file selector 420, an object instance creator 430, an object list manager 440, clone list manager 450, and a target document generator 460.

Source file retriever 410 may include hardware and software components. In one implementation, source file retriever 410 may retrieve or receive a source document 110, such as an XML report or JSON file, for a particular user or application. An internal source document (e.g., an XML report) may be generated, for example, in response to a user query, a request from an application, and/or as part of a scheduled reporting procedure. Source file retriever 410 may retrieve the appropriate internal file (e.g., from input file storage 220) associated with the particular user or application.

Configuration file selector 420 may include hardware and software components. In one implementation, configuration file selector 420 may match a particular configuration file (e.g., MJTCF 130) with a particular user or application. For example, based on information on a user identified in (or associated with) source document 110 retrieved by source file retriever 410, configuration file selector 420 may find the appropriate configuration file from configuration file storage 230 associated with the particular user. In one implementation, the particular user may be associated with an access level for which a particular configuration file regulates data access.

Object instance creator 430 may include hardware and software components. In one implementation, object instance creator 430 may read commands in configuration file 130 and create a corresponding object instance (e.g., a matcher instance) that implements each command. Object instance creator 430 may assemble a group of matcher instances 135 to apply to a source file (e.g., source document 110 retrieved by source file retriever 410).

Object list manager 440 may include hardware and software components. In one implementation, object list manager 440 may manage the use of matcher instances 135 during processing of source document 110. For example, object list manager 440 may track which matcher instances 135 are to be applied or not applied during a character-by-character check of terms in source document 110, as described above in connection with FIG. 1. In one implementation, object list manager 440 may include all available matcher instances 135 for checking a first character in a term of source document 110. Object list manager 440 may remove from the active group of matcher instances 135 any instances that are not a match for the first character and continue to remove commands from the object list for any subsequent non-matching characters in a term. If there is a matching character of a matcher instance 135 with the current character being scanned, then the next character from source document 110 is checked, and so forth, until a complete term (e.g., a word, string, or multiple strings of characters) is confirmed as match. After a term is confirmed as a match or no match, object list manager 440 may include all available command instances for checking a first character of the next term.

Matching list manager 450 may include hardware and software components. Matching list manager 450 may create an ordered list of matched instances (e.g., matching matcher instances 140). For any matcher instance 135 that completes a match of all characters being tested, the matching instance is cloned and put into matching matcher instances 140. As described above in connection with FIG. 1, the clone may include a copy of the matched term and a reference to the memory location within source document 110 where the match occurred.

Target document generator 460 may include hardware and software components to generate a report or file (e.g., target document 150) in accordance with the user access levels as governed by a selected MJTCF 130. For example, target document generator 440 may process source document 110 against matching matcher instances 140 in reverse order. Each commands for each matcher instance 135 may be executed for a corresponding matching term (e.g., REMOVE, REPLACE, etc.). Matching matcher instances 140 is processed in reverse order to prevent alteration of the in-memory target locations. For example, assuming each item in the clone list contains information about the length of data in a partition. If a forward scan modifies the data (and therefore its length), the location of the next item becomes incorrect. That is, if changes were made the first part of the input file then all other match offsets (e.g., locations indicators) could become invalid. When all the object instances from the clone list are complete, target document generator 460 may save and/or issue the completed output report or file (e.g., as target document 150).

Although FIG. 4 shows exemplary logical components of transform engine 120, in other implementations, transform engine 120 may include fewer, different, differently-arranged, or additional logical components than those depicted in FIG. 4. Alternatively, or additionally, one or more logical components of transform engine 120 may perform one or more other tasks described as being performed by one or more other logical components of transform engine 120.

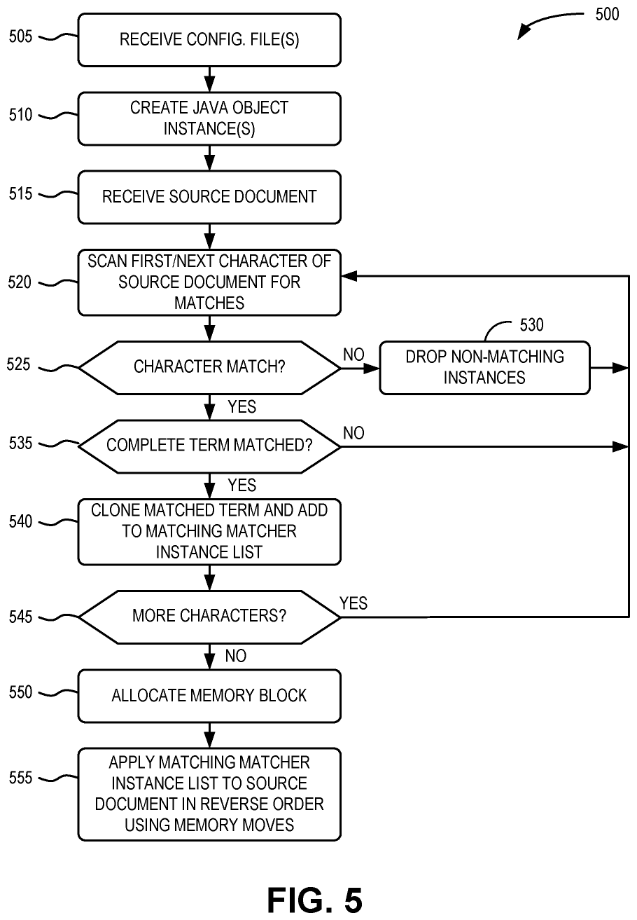

FIG. 5 is a diagram of an exemplary process 500 for transforming an input file using in memory pattern matching. In one implementation, process 500 may be performed by transform engine 120. In another implementation, some or all of process 500 may be performed by another device or group of devices, including or excluding transform engine 120. For example, another device in service provider network 205 may perform one or more parts of process 500.

As shown in FIG. 5, process 500 may include receiving one or more configuration files for a data report (block 505), and creating JAVA object instances for commands in the configuration file (block 510). For example, transform engine 120 may receive a configuration file (e.g., MJTCF 130) for transforming data reports (e.g., source document 110) from a data source (e.g., input file storage 220). Transform engine 120 may generate object instances for each of the commands in the configuration file.

Process 500 may further include receiving a source document (block 515). For example, transform engine 120 may obtain source document 110 generated by the data source (e.g. input file storage 220). Transform engine 120 may select/identify a MJTCF 130 for the source document. In one implementation, Transform engine 120 may select a configuration file based on the report type. In another implementation, transform engine 120 may select a configuration file based on information about the user or application.

Process 500 may also include scanning the source document by character-by-character for instance matches (block 520) and determining if there is a character match (block 525). For example, transform engine 120 may perform a single character-by-character scan of source document 110. In one implementation, transform engine 120 may generate a list of object instances from configuration file 130 and apply expressions (or terms) in each of the object instances to a first character of source document 110. For example, transform engine 120 may attempt to match a first character from an expression/term to each matcher instance 135 with the first character of source document 110.

If there is not a character match (block 525—NO), process 500 may include dropping non-matching instances from the list of object instances (block 530), and scanning the next character of the source document against the remaining object instances (block 520). For example, transform engine 120 may update the group of matcher instances 135 to remove instances with non-matching expressions to the first character of source document 110. Transform engine 120 may apply expressions in the remaining matcher instances 135 from the updated group of matcher instances 135 to a second character of source document 110.

If there is a character match (block 525—YES), process 500 may include determining if there is a complete term matched (block 535). For example, transform engine 120 may continue to scan source document 110 character-by-character until a match of a character in source document 110 completes a term that matches an expression of a matcher instance 135 or until a scan of all characters is completed.

If there is a complete term matched (block 535—YES), process 500 may include adding a clone of the matched term to a matching matcher instance list (block 540). For example, when a match of a character in source document 110 completes term that matches an expression of a matcher instance 135, transform engine 120 may begin an ordered list of cloned terms (e.g., matching matcher instances 140) corresponding to the matcher instances. Each of the cloned terms may identify a location within source document 110.

If there is not a complete term matched (block 535—NO) or if there are more characters in the source document (block 545—YES), process 500 may return to block 520 to continue the character-by-character scan. The cycle may be repeated until the entire source document 110 has been scanned for matches.

If there are no more characters in the source document (block 545—NO), process 500 may include allocating a memory block for a transformation process (block 550) and applying the matching matcher instance list to the source document in reverse order using memory moves (block 555). For example, transform engine 120 may allocate, based on the ordered list of cloned terms, a RAM block for transforming source document 110. The RAM block size may be determined based on the number and size of items in matching matcher instances 140. Transform engine 120 may then perform operations of the matching matcher instances in reverse order of the ordered list of cloned terms. Performing the operations may include using memory move operations within the allocated RAM block. When transform engine 120 has finished working backwards through the clone list, a transformed source document may be, for example, stored in target document storage 240 and/or provided as target document 150. Target document 150 may be forwarded, for example, to user device 260 or interface server 250 for presenting to a user or ingesting by an application.

Systems and methods described herein optimize use of computing resources to perform file transformations by using in memory pattern matching. A computing device receives a configuration file for transforming data from a data source, creates object instances for commands in the configuration file, and obtains a source document generated from the data source. The computing device performs a single character-by-character scan of the source document and creates an ordered list of matching terms corresponding to the objet instances. Each of the matching terms in the ordered list identifies a location within the source document. The computing device allocates, based on the ordered list of matching terms, a RAM block for transforming the source document and performs operations of the object instances in reverse order of the ordered list of matching terms. The operations include memory move operations within the allocated RAM block. The performing creates a transformed source document for a user.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. thus, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described with regard to the processes illustrated in FIG. 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 215, etc.), or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 215) of a device. A non-transitory storage medium includes one or more of the storage mediums described in relation to memories 320/330/340.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a computing device, a configuration file for transforming data reports from a data source;
creating, by the computing device, object instances for commands in the configuration file;
obtaining, by the computing device, a source document generated from the data source;
performing, by the computing device, a single character-by-character scan of the source document;
creating, by the computing device and based on the character-by-character scan, an ordered list of matching terms corresponding to the object instances, wherein each of the matching terms identifies a location within the source document;
allocating, by the computing device and based on the ordered list of matching terms, a random access memory (RAM) block for transforming the source document;
performing, by the computing device and on the source document, operations of the object instances in reverse order of the ordered list of matching terms, wherein performing the operations includes using memory move operations within the allocated RAM block, and wherein the performing creates a transformed source document; and
providing, by the computing device, the transformed source document.

2. The method of claim 1, wherein performing the character-by-character scan comprises:
generating a list of object instances from the configuration file,
applying expressions in each of the object instances to a first character of the source document,
updating, after the applying, the list of object instances to remove object instances with non-matching expressions to the first character, and
applying expressions in the object instances from the updated list of object instances to a second character of the source document.

3. The method of claim 1, wherein the ordered list of matching terms includes matching terms in sequence of a first to a last occurrence within the source document.

4. The method of claim 1, wherein using the memory move operations within the allocated RAM block includes:
altering first data, corresponding to a first matching term, to form transformed first data;
performing a memory move of any unaltered data after the transformed first data;
altering second data, corresponding to a second matching term, to form transformed second data; and
performing a memory move of data after the transformed second data.

5. The method of claim 1, wherein the configuration file includes commands to replace, remove, or de-identify values in the source document.

6. The method of claim 1, wherein the input file includes an Extensible Markup Language (XML) or Java Script Object Notation (JSON) file format.

7. The method of claim 1, wherein the source document includes a report for a particular user, and wherein the configuration file defines output requirements for the particular user.

8. A computing device, comprising:
a network interface to communicate with one or more remote systems;
one or more memories to store instructions; and
one or more processors configured to execute instructions in the one or more memories to:
receive a configuration file for transforming data reports from a data source;
create object instances for commands in the configuration file;
obtain a source document generated from the data source;
perform a single character-by-character scan of the source document;
create, based on the character-by-character scan, an ordered list of matching terms corresponding to the objet instances, wherein each of the matching terms identifies a location within the source document;
allocate, based on the ordered list of matching terms, a random access memory (RAM) block for transforming the source document;
perform on the source document operations of the object instances in reverse order of the ordered list of matching terms, wherein performing the operations includes using memory move operations within the allocated RAM block, and wherein the performing creates a transformed source document; and
provide the transformed source document to another computing device.

9. The computing device of claim 8, wherein, when performing the character-by-character scan, the one or more processors are further configured to execute the instructions in the one or more memories to:
generate a list of object instances from the configuration file,
apply expressions in each of the object instances to a first character of the source document,
update, after the applying, the list of object instances to remove object instances with non-matching expressions to the first character, and
apply expressions in the object instances from the updated list of object instances to a second character of the source document.

10. The computing device of claim 8, wherein the ordered list of matching terms includes matching terms in sequence of a first to a last occurrence within the source document.

11. The computing device of claim 8, wherein, when using memory move operations within the allocated RAM block, the one or more processors are further configured to execute the instructions in the one or more memories to:
alter first data, corresponding to a first matching term, to form transformed first data;
perform a memory move of any unaltered data after the transformed first data;
alter second data, corresponding to a second matching term, to form transformed second data; and
perform a memory move of:
unaltered data between the transformed second data and the transformed first data,
the altered first data, and
any unaltered data after the transformed first data.

12. The computing device of claim 8, wherein the configuration file includes commands to replace, remove, or de-identify values in the source document.

13. The computing device of claim 8, wherein the input file includes an Extensible Markup Language (XML) or Java Script Object Notation (JSON) file format.

14. The computing device of claim 8, wherein the source document includes a report for a particular user, and wherein the configuration file defines output requirements for the particular user.

15. A non-transitory, computer-readable storage medium storing instructions executable by a processor of a first network element, which when executed cause the first network element to:
receive a configuration file for transforming data reports from a data source;
create object instances for commands in the configuration file;
obtain a source document generated from the data source;
perform a single character-by-character scan of the source document;
create, based on the character-by-character scan, an ordered list of matching terms corresponding to the objet instances, wherein each of the matching terms identifies a location within the source document;
allocate, based on the ordered list of matching terms, a random access memory (RAM) block for transforming the source document;
perform on the source document operations of the object instances in reverse order of the ordered list of matching terms, wherein performing the operations includes using memory move operations within the allocated RAM block, and wherein the performing creates a transformed source document; and
provide the transformed source document to another computing device.

16. The non-transitory, computer-readable storage medium of claim 15, wherein the instructions to perform the character-by-character scan further comprise instructions to:
generate a list of object instances from the configuration file,
apply expressions in each of the object instances to a first character of the source document,
update, after the applying, the list of object instances to remove object instances with non-matching expressions to the first character, and
apply expressions in the object instances from the updated list of object instances to a second character of the source document.

17. The non-transitory, computer-readable storage medium of claim 15, wherein the instructions to use memory move operations within the allocated RAM block further comprise instructions to:
alter first data, corresponding to a first matching term, to form transformed first data; and
perform a memory move of any data after the transformed first data.

18. The non-transitory, computer-readable medium of claim 15, wherein the configuration file includes commands to replace, remove, or de-identify values in the source document.

19. The non-transitory, computer-readable storage medium of claim 15, wherein the source document includes a report for a particular access level, and wherein the configuration file defines output requirements for the particular access level.

20. The non-transitory, computer-readable storage medium of claim 15, wherein the ordered list of matching terms includes matching terms in sequence of a first to a last occurrence within the source document.
